(19) United States
(12) Patent Application Publication
(10) Pub. No.: US 2025/0184787 A1
(43) Pub. Date: Jun. 5, 2025

(54) NETWORK CONTROLLED METHOD FOR MEASUREMENT GAP ADAPTATION

(71) Applicant: Nokia Technologies Oy, Espoo (FI)

(72) Inventors: Halit Murat GÜRSU, Munich (DE); Srinivasan SELVAGANAPATHY, Bangalore (IN); Samantha CAPORAL DEL BARRIO, Aalborg (DK); Daniela LASELVA, Aalborg (DK); Panagiotis SPAPIS, Munich (DE); Lars DALSGAARD, Oulu (FI)

(21) Appl. No.: 18/695,183

(22) PCT Filed: Sep. 9, 2022
(86) PCT No.: PCT/FI2022/050604

§ 371 Date: Mar. 25, 2024

(30) Foreign Application Priority Data
Sep. 29, 2021 (IN) 202141044186

(51) Int. Cl. H04W 24/10; H04B 17/318; H04L 41/0816

(52) U.S. Cl. CPC H04W 24/10; H04B 17/328; H04L 41/0816

(57) ABSTRACT

Systems, methods, apparatuses, and computer program products for network-controlled measurement gap adaptation for a user equipment are provided. For example, a method can include receiving, by a user equipment from a network element, a first measurement gap configuration. The method can also include performing, by the user equipment, measurements on a set of beams that can include a first plurality of beams based on the first measurement gap configuration. The method can further include determining, by the user equipment, that a subset of the beams comprising a second plurality of beams meets a condition. The method can additionally include sending, by the user equipment, a report to the network element based on the determination that the subset of the beams meets the condition. The report can be configured to trigger a reconfiguration of the first measurement gap configuration.

### CROSS REFERENCE TO RELATED APPLICATION

This application claims priority from Indian provisional patent application no. 202141044186 filed on Sep. 29, 2021. The contents of this earlier filed application are hereby incorporated by reference in their entirety.

### FIELD

Some example embodiments may generally relate to communications including mobile or wireless telecommunication systems, such as Long Term Evolution (LTE) or fifth generation (5G) radio access technology or new radio (NR) access technology, or other communications systems. For example, certain example embodiments may generally relate to systems and/or methods for providing network-controlled measurement gap adaptation for a user equipment.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to an apparatus. The apparatus can include at least one processor and at least one memory comprising computer program code. The at least one memory and computer program code can be configured, with the at least one processor, to cause the apparatus at least to perform a process. The process can include receiving, from a network element, a first measurement gap configuration. The process can also include performing measurements on a set of beams that can include a first plurality of beams based on the first measurement gap configuration. The process can further include determining that a subset of the beams comprising a second plurality of beams meets a condition. The process can additionally include sending a report to the network element based on the determination that the subset of the beams meets the condition. The report can be configured to trigger a reconfiguration of the first measurement gap configuration.

An embodiment may be directed to an apparatus. The apparatus can include at least one processor and at least one memory comprising computer program code. The at least one memory and computer program code can be configured, with the at least one processor, to cause the apparatus at least to perform a process. The process can include receiving, from a network element, a first measurement gap configuration and a measurement report condition to detect a measurement gap change. The process can also include performing measurements on a set of beams that can include a first plurality of beams based on the first measurement gap configuration. The process can, moreover, include determining, using the measurement report condition, that a change of measurement gap is needed. The process can further include sending a first report of the measurements to the network element, indicating a change of the measurement gap. The process can additionally include receiving a reconfiguration message from the network element with a new measurement gap based on the report.

An embodiment may be directed to an apparatus. The apparatus can include at least one processor and at least one memory comprising computer program code. The at least one memory and computer program code can be configured, with the at least one processor, to cause the apparatus at least to perform a process. The process can include sending, to a user equipment, a first measurement gap configuration. The user equipment can be configured to perform measurements on a set of beams that can include a first plurality of beams based on the first measurement gap configuration. The process can also include receiving a report indicating that a subset of the beams comprising a second plurality of beams meets a condition. The process can further include triggering a reconfiguration of the first measurement gap configuration for the user equipment based on the report.

An embodiment may be directed to an apparatus. The apparatus can include at least one processor and at least one memory comprising computer program code. The at least one memory and computer program code can be configured, with the at least one processor, to cause the apparatus at least to perform a process. The process can include sending, to a user equipment, a first measurement gap configuration and a measurement report condition to detect a measurement gap change. The process can also include receiving a first report of measurements performed on a set of beams that can include a first plurality of beams based on the first measurement gap configuration. The process can further include triggering reconfiguration of the user equipment with a reconfiguration message. The reconfiguration message can include a new measurement gap based on the report. The reconfiguration message can further identify a condition regarding measurements.

An embodiment may be directed to a method. The method can include receiving, by a user equipment from a network element, a first measurement gap configuration. The method can also include performing, by the user equipment, measurements on a set of beams that can include a first plurality of beams based on the first measurement gap configuration. The method can further include determining, by the user equipment, that a subset of the beams comprising a second plurality of beams meets a condition. The method can additionally include sending, by the user equipment, a report to the network element based on the determination that the subset of the beams meets the condition. The report can be configured to trigger a reconfiguration of the first measurement gap configuration.

An embodiment may be directed to a method. The method can include receiving, by a user equipment from a network element, a first measurement gap configuration and a measurement report condition to detect a measurement gap change. The method can also include performing, by the user equipment, measurements on a set of beams that can include a first plurality of beams based on the first measurement gap configuration. The method can, moreover, include determining, using the measurement report condition, that a change of measurement gap is needed. The method can further include sending, by the user equipment, a first report of the measurements to the network element, indicating a change of the measurement gap. The method can additionally include receiving, by the user equipment, a reconfiguration message from the network element with a new measurement gap based on the report.

An embodiment may be directed to a method. The method can include sending, by a network element to a user equipment, a first measurement gap configuration. The user equipment can be configured to perform measurements on a set of beams that can include a first plurality of beams based on the first measurement gap configuration. The method can also include receiving, by the network element, a report indicating that a subset of the beams comprising a second plurality of beams meets a condition. The method can further include triggering, by the network element, a reconfiguration of the first measurement gap configuration for the user equipment based on the report.

An embodiment may be directed to a method. The method can include sending, by a network element to a user equipment, a first measurement gap configuration and a measurement report condition to detect a measurement gap change. The method can also include receiving, by the network element, a first report of measurements performed on a set of beams that can include a first plurality of beams based on the first measurement gap configuration. The method can further include triggering, by the network element, reconfiguration of the user equipment with a reconfiguration message. The reconfiguration message can include a new measurement gap based on the report. The reconfiguration message can further identify a condition regarding measurements. An embodiment may be directed to an apparatus. The apparatus can include means for receiving, from a network element, a first measurement gap configuration. The apparatus can also include means for performing measurements on a set of beams that can include a first plurality of beams based on the first measurement gap configuration. The apparatus can also include means for determining that a subset of the beams comprising a second plurality of beams meets a condition. The apparatus can further include means for sending a report to the network element based on the determination that the subset of the beams meets the condition. The report can be configured to trigger a reconfiguration of the first measurement gap configuration.

An embodiment may be directed to an apparatus. The apparatus can include means for receiving, from a network element, a first measurement gap configuration and a measurement report condition to detect a measurement gap change. The apparatus can also include means for performing measurements on a set of beams that can include a first plurality of beams based on the first measurement gap configuration. The apparatus can, moreover, include means for determining, using the measurement report condition, that a change of measurement gap is needed. The apparatus can further include means for sending a first report of the measurements to the network element, indicating a change of the measurement gap. The apparatus can additionally include means for receiving a reconfiguration message from the network element with a new measurement gap based on the report.

An embodiment may be directed to an apparatus. The apparatus can include means for sending, to a user equipment, a first measurement gap configuration. The user equipment can be configured to perform measurements on a set of beams that can include a first plurality of beams based on the first measurement gap configuration. The apparatus can also include means for receiving a report indicating that a subset of the beams comprising a second plurality of beams meets a condition. The apparatus can further include means for triggering a reconfiguration of the first measurement gap configuration for the user equipment based on the report.

An embodiment may be directed to an apparatus. The apparatus can include means for sending, to a user equipment, a first measurement gap configuration and a measurement report condition to detect a measurement gap change. The apparatus can also include means for receiving a first report of measurements performed on a set of beams that can include a first plurality of beams based on the first measurement gap configuration. The apparatus can further include means for triggering reconfiguration of the user equipment with a reconfiguration message, wherein the reconfiguration message comprises a new measurement gap based on the report, wherein the reconfiguration message further identifies a condition regarding measurements.

### BRIEF DESCRIPTION OF THE DRAWINGS

For proper understanding of example embodiments, reference should be made to the accompanying drawings, wherein:

FIG. 1 illustrates measurement gap configuration in relationship to retuning time;

FIG. 2 illustrates an example of measurement gap configuration;

FIG. 3 illustrates face and edge designs for a multipanel user equipment;

FIG. 4 illustrates distribution of synchronization signal blocks;

FIG. 5 illustrates a relationship between secondary synchronization signal reference signal received power values and various beams and measurements;

FIG. 6 illustrates a signal flowchart according to certain embodiments;

FIG. 7 illustrates another signal flowchart according to certain embodiments;

FIG. 8 illustrates simulation results from a reduction in measurement gap length, according to certain embodiments;

FIG. 9 illustrates an example flow diagram of a method, according to an embodiment;

FIG. 10 illustrates an example flow diagram of a method, according to an embodiment;

FIG. 11 illustrates an example flow diagram of a method, according to an embodiment;

FIG. 12 illustrates an example flow diagram of a method, according to an embodiment;

FIG. 13A illustrates an example block diagram of an apparatus, according to an embodiment; and

FIG. 13B illustrates an example block diagram of an apparatus, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing network-controlled measurement gap adaptation for a user equipment, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Certain embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Certain embodiments may relate to enhancements for new radio (NR) related to measurement gaps for multi-panel UEs (MPUEs) in frequency range 2 (FR2) (for is example, from 24.25 GHz to 52.6 GHz) and other scenarios.

Measurement gaps in NR are in some ways similar to those in long term evolution (LTE). Similarly to LTE, certain user equipment (UEs) in radio resource control (RRC) connected mode in NR may need to be configured by a serving cell with a measurement gap to measure inter-frequency and inter-RAT neighbor cells. Additionally, there may be situations where in NR the UE would need gaps to measure intra-frequency. For example, the UE may need to perform radio resource management (RRM) measurements of neighbor cells of the serving carrier.

A measurement gap can refer to a period where the UE may perform RRM measurements and where the UE is not required to do transmission/reception with the serving cell. For example, in a measurement gap, the serving cell should not schedule (but may schedule) transmissions to the UE and may not expect to receive transmissions from the UE.

The need for measurement gaps may depend on the UE capability and may be indicated by the UE to the network. The indication can be through information elements such as interFreqNeedForGaps or interRAT-NeedForGaps in LTE and nr-NeedForGap-Reporting-r16 or interFrequencyMeas-NoGap-r16 in NR. The need for gap assistance for performing measurements may be UE-implementation-specific and may additionally depend on, for example, the active bandwidth part (BWP) and current operating frequency of the UE. There are standards that define such measurement gap usage.

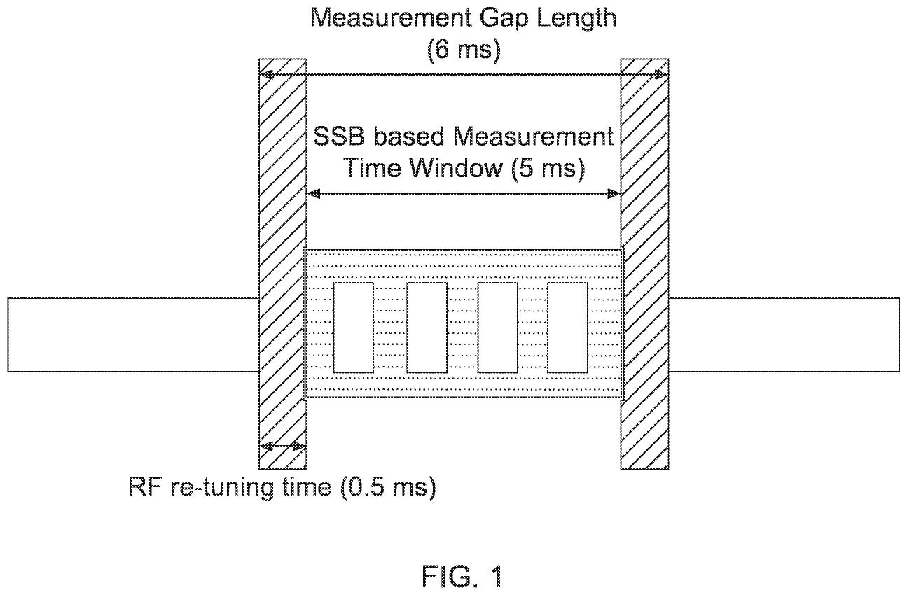

FIG. 1 illustrates measurement gap configuration in relationship to retuning time. More particularly, FIG. 1 shows details related to measurement gap configuration and how the radio frequency (RF) retuning time and synchronization signal (SS) burst are considered for the measurement gap configuration.

Measurement gap lengths (MGL) of 1.5, 3, 3.5, 4, 5.5, and 6 ms have been supported to ensure a good match with the synchronization signal block (SSB) RRM measurement timing configuration (SMTC) window length. As shown in FIG. 1, the MGL can take account the RF re-tuning time of 0.5 ms and 0.25 ms for carrier frequency measurements in frequency range 1 (FR1) (for example, from 450 MHz to 6 GHz) and FR2, respectively. MGL can be set to the SMTC window length+2× returning time.

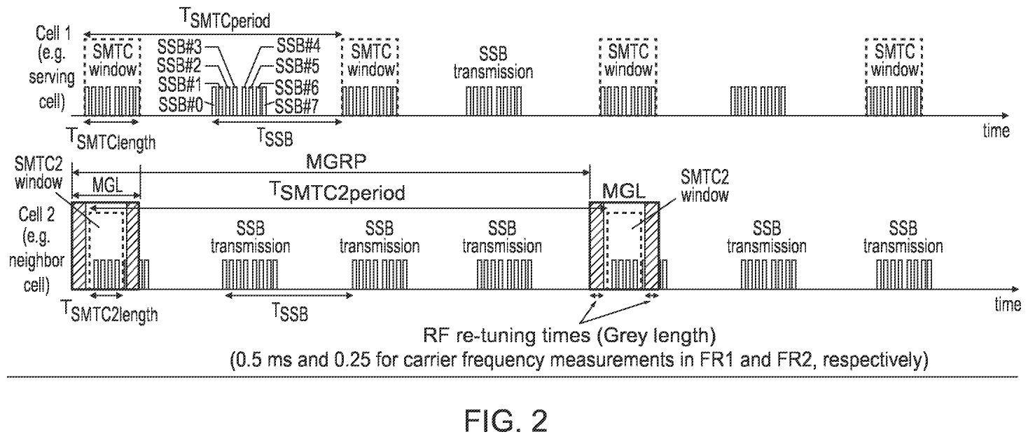

FIG. 2 illustrates an example of measurement gap configuration. In FIG. 2, examples are provided for measurement gap length, measurement gap repetition period (MGRP), SMTC window period (TSMTCperiod), SMTC window length TSMTClength. TSMTClength can be set to a value to allow the UE to measure all transmitted SSBs or all SSBs in SSB-ToMeasure, if configured. Example of SSB transmission with 8 transmitted SSB beams in both Cell 1 and 2 (the number of SSBs configured can be different per cell).

In FR2, both the gNB and UE may operate using narrow beams. In this context, narrow beams can refer to operation of the gNB using radiation patterns narrower than sector-wide beams as in LTE. Likewise, the UE can operate using radiation patterns narrower than omni-directional beams. The reasons for the beam-based operations may depend on the need for an increased array/antenna gain to compensate the higher path loss at mmWaves, but also due to technological limitations. Multiple panels may be active simultaneously. In certain implementations, just one panel can be used for uplink transmission.

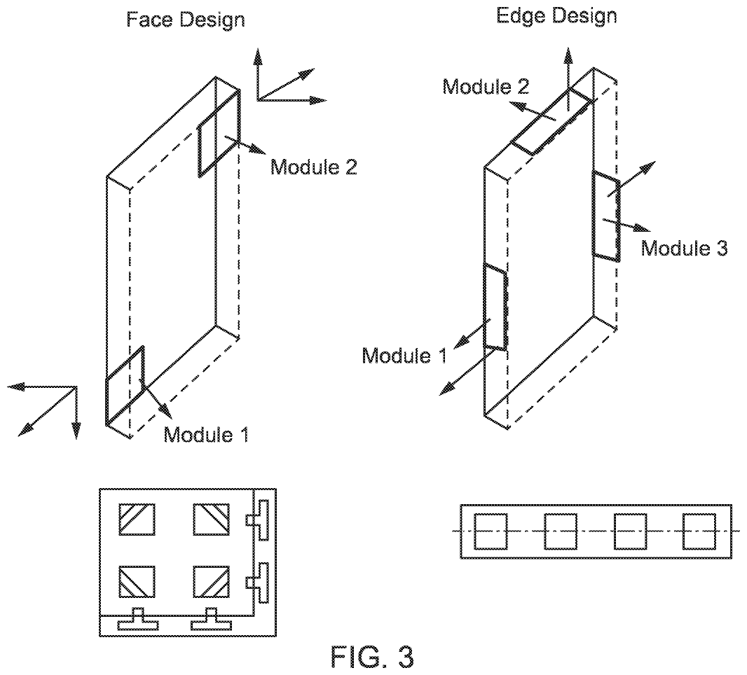

FIG. 3 illustrates an example of face and edge designs for a multipanel user equipment. FIG. 3 also shows the antenna module structure and the boresight directions of the main scanning plane(s) of all the subarrays of this example. More particularly, examples of the “face” (left side) and “edge panel design” (right side) are presented in in FIG. 3. As shown, the “face panel design” has two dual-polarized patch subarrays and two 2×1 (single-polarized) dipole subarrays at the edges of the module and the “edge panel design” has linear dual-polarized patch subarrays placed on three edges of the UE.

There can be a measurement gap configuration for a multipanel UE (MPUE) in NR FR2. The measurement gap and SMTC duration can be configured such that the UE can identify and measure all the SSBs within the SMTC window. For example, the SMTC duration can be configured to be sufficient to accommodate the SSBs that are being transmitted. The SMTC window and MGL can be configured to allow the UE to measure all transmitted SSBs. There may be up to 64 SSB beams transmitted per cell in FR2, so the SMTC window and MGL can be designed to allow the largest values of SSBs in general and also for MPUEs. If the SMTC window is 5 ms, then typically the MGL may be 6 or 5.5 ms. In NR, the UE can indicate the need for a measurement gap if the UE needs measurement gaps for performing measurements through the field for the information element (IE), ‘needForGapsInfoNR’. This field may be used to indicate the measurement gap requirement information of the UE for NR target bands.

As part of the measurement configuration transmitted by the serving cell to the UE, the Measurement Gap Length (MGL) may be set to allow measuring all the SSB beams transmitted by the neighbor cells that falls within the gap (e.g. 8 and up to 64).

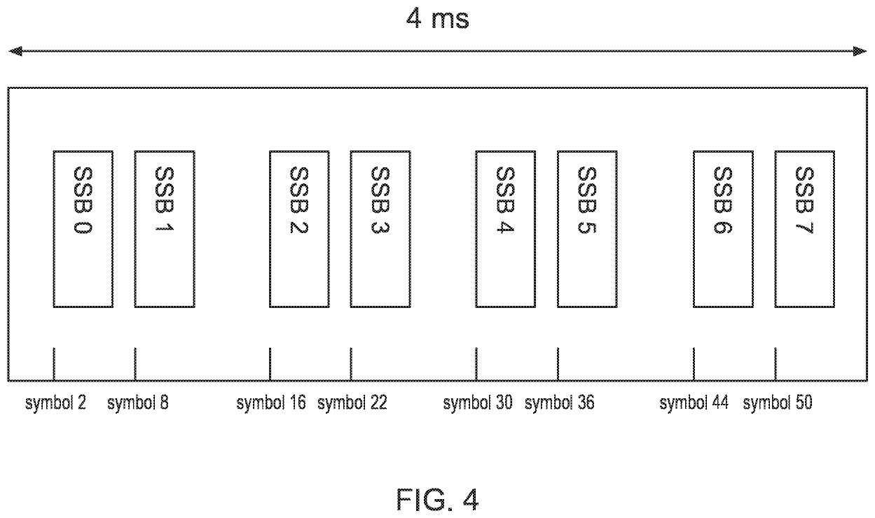

FIG. 4 illustrates an example distribution of synchronization signal blocks. More particularly, FIG. 4 illustrates distribution of SSBs over consecutive symbols and in detail explanation of their duration (example of 8 SSBs).

As shown in an example for 15 kHz in FIG. 4, the first SSB can start from symbol 2 of the radio frame and the last SSB can start at symbol 50. The SSB beam starting indices for 15 kHz can be 2, 8, 16, 22, 30, 36, 44, and 50 for SSB 0-7, respectively. Given the 4-symbol duration of each SSB, and 2 to 4 symbols separation between each of the adjacent 8 SSBs, the SSB burst can span 5 ms. The maximum SSB burst spans of 5 ms may be valid under any configuration, irrespective of the number of transmitted SSB beams.

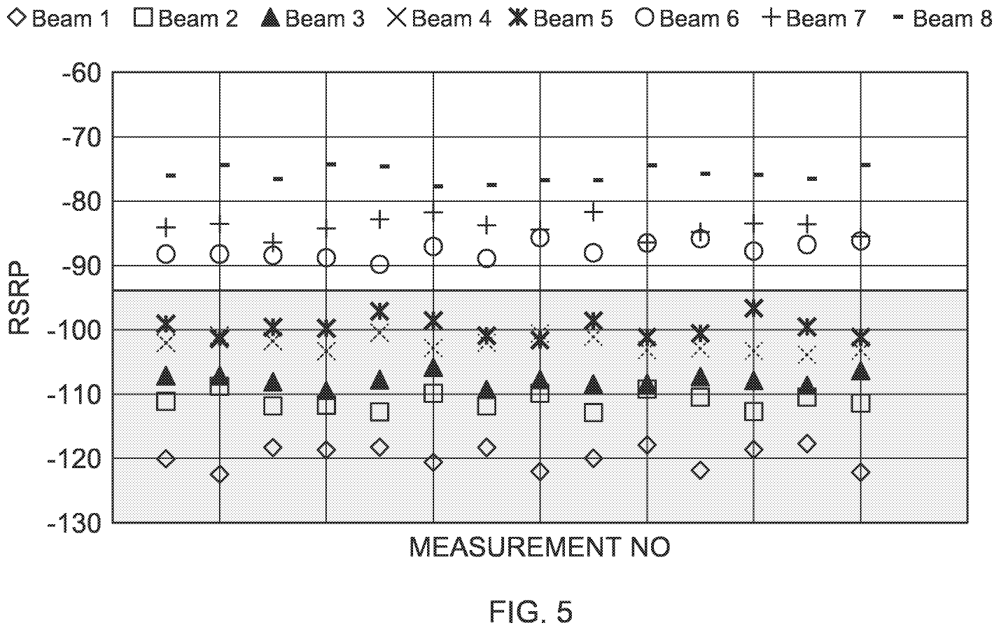

FIG. 5 illustrates an example of a relationship between secondary synchronization signal (SS) reference signal received power (SS-RSRP) values and various beams and measurements. More particularly, FIG. 5 provides an example of a UE's SS-RSRP values corresponding to SSB ID 1-8 of a cell. In this example, out of the 8 beams transmitted by the cell and that UE is configured to measure, only 3 of them are relevant for UE mobility procedures after a certain number of measurements (for example, having an RSRP value above −95 dBm).

Thus, FIG. 5 illustrates an example of UE's SS-RSRP values corresponding to SSB ID 1-8 of a cell. In this example, only 3 SSB beams out of the 8 SSB beams that the cell transmitted and that the UE was configured to measure, may be relevant for UE mobility procedures. In this example, a relevant beam is a beam having a measured SS-RSRP value >−95 dBm.

In the example above, as the relevant SSB beams are only three (SSB beam 5, 6, and 7), SSB beams 0-5 can be relaxed or skipped. In other words, these other beams may not be measured at all or may be measured less often compared to the relevant beams. For example, the less relevant beams may not be measured for some of the periodic measurements by the UE. Thus, the UE and/or the network can consider some of the measurements as less important. In this case, and the SSB measurements could actually start from symbol 36 (rather than symbol 2) leaving the other SSB symbols as unmeasured.

Therefore, the actual efficient measurement time needed for measuring the relevant SSB beams can be shorter than the configured measurement gap and SMTC window. In the example described above, there may be an gap of additional 34 symbols that is potentially unnecessary. In turn, these symbols could have been used by the serving cell for throughput improvement. For example, the serving cell could have used those OFDM symbols that are not needed for measurements for data transmission, and thereby could have achieved a higher data rate.

Thus, certain measurement gap and SMTC window configurations can be inflexible and there may be an unnecessarily long gap allocation where part of the gap could be used for other purposes, such as throughput improvement.

In NR, measGapConfig has included a variety of information elements, some of which are optional. For example, measGapConfig can include gapFR2, gapFR1, gapUE, and gapOffset, as well as mg1, mgrp, and mgta.

Measurement gap re-configuration can be performed through RRC signaling. The network may be aware of L1/L3 beam measurements, for example SS-RSRP, which may be reported by the UE. The network can detect that only a subset of beams are relevant for the UE. After detecting this, the network can trigger a measurement gap re-configuration through RRC signaling.

This may be a slow and sub-optimal adaptation process. The speed of the adaptation may not keep up with respect to radio change of the UE, particularly for UEs that are in a dynamic radio environment, such as mobile UEs. L3 beam measurements may not necessarily provide enough information for this optimization. L3 beam measurements are configured to optimize UE mobility procedure and such optimization can be missed.

Certain embodiments may help optimize measurement gaps for UEs that without measurement gaps would not be able to measure neighbor cells. More particularly, in certain embodiments, a dynamic network controlled measurement gap updating and optimizing method can be used. In an embodiment, one or more measurement gap parameter values that relate to the UE's measurement gap can be updated. This can include updates to, for example, measurement gap length (MGL), gap periodicity (MGRP) and offset (gapOffset) based on the actual need of the UE.

According to an embodiment, the method may include that the RRC layer can configure the UE with a network assistance information called “change gap” that comes with, e.g., an RSRP threshold and one or more neighbor beams which RSRP is to be compared against the threshold.

In certain embodiments, a UE may use the assistance information and can provide information on the neighbor SSB RSRP versus one or more thresholds or request update of one or more measurement gap's parameters (e.g., measurement gap length, periodicity and offset) or complete measurement gap pattern.

In one example, the UE update request could be based on the beam measurements (SS-RSRP/RSRQ/SINR) measured by the UE and that relate to the measurement gap (i.e. the beam measurements of a neighbor cell measured using the measured gap). The update request can be within an allowed range of configured parameters or MGPs configured by the RRC layer. In one example, the request can be in accordance with currently possible measurement gap configurations. In another embodiment, new measurement gap configurations can be suggested for further optimization of measurement gaps.

In one example, the method can lead to the UE alternating between shorter gaps and full covering gaps (covering the full SMTC), e.g., allowing that UE falls back to the original measurement gap in which 1 (or more) out of 10 (or more) measurement gaps may be allocated to enable sweep covering the available transmitted beams.

In a further embodiment, instead of network or UE assistance information, a new measurement report can assist measurement gap optimization. The configured event-based measurement report can trigger a measurement gap adaptation report or request. The use of a Meas-gap measurement report, for example Meas Gap Shrink, Meas Gap Expand MR, or both, can be adapted in various ways. For example, the use of the Meas-gap measurement can permit conditional measurement gap adaptation that the UE conducts automatically. Additionally or alternatively, after an A2 event is triggered, a measurement gap with a Meas Gap Shrink event based MR can be configured to the UE. As another alternative, a Meas Gap Expand event based MR can be a pre-requisite before A3 event configuration.

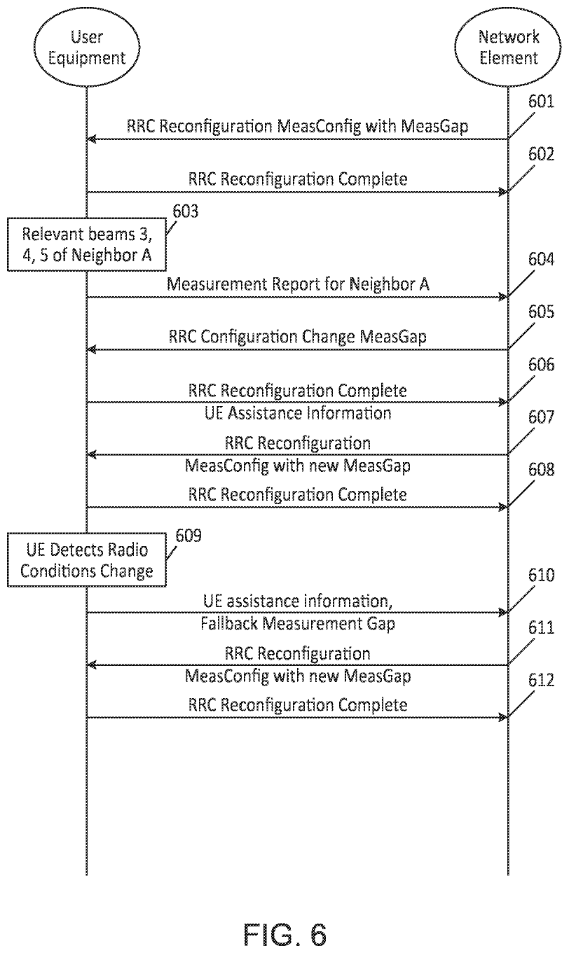

FIG. 6 illustrates a signal flowchart according to certain embodiments. More particularly, FIG. 6 illustrates a chart of a sequence of messages incorporating UE assistance information in certain places. The messages shown can be between a user equipment and a network element, such as a gNB of a serving cell.

As shown in FIG. 6, at 601 the RRC layer can configure the UE with a measurement gap through RRC configuration message. The message can include a MeasGap length enabling the UE to sweep all SSBs. At 602, the UE can acknowledge the MeasGap configuration with an RRC reconfiguration complete procedure.

At 603, the UE can perform measurements related to Measurement Configuration that came with the Measurement Gap configuration. In certain embodiments, the UE can detect that MeasGap can be optimized. For example, a certain number of beams measured with a measurement gap may be detected as being below a certain threshold, e.g., L1_b1, L1_b2, . . . L1_b4<Thr. In one embodiment, the threshold may be, for example, −95 dB.

At 604, the UE can send the measurement report including beam index and measurements of the neighbor measurements to the network (NW). At 605, the network can ask the UE for a MeasGap change and can include RRC Configuration. The network can include a threshold and number of beams of the neighbor that should be compared against this threshold with the MeasGap Change message.

Following the MeasGap change message, at 606 the UE can answer with a request of a measurement gap optimization with an RRC Configuration complete message.

At 607, the RRC layer in the network can send a reduced MeasGap configuration to the UE. This reduced MeasGap configuration can indicate one or more of a variety of possible changes. For example, the reduced MeasGap configuration can indicate to reduce the size of the measurement gap, such as from 5 ms to 2 ms, for a reduction from covering 8 to 3 SSB beams. As another example, the reduced MeasGap configuration can indicate to reduce or increase the measurement gap periodicity with respect to change in the beam RSRPs. As a further example, the reduced MeasGap configuration can indicate to switch to full measurement gap length configuration, covering the full SMTC, with a periodicity of, for example, 1 or 5 out of 10 or 50 measurement gap repetitions. The full measurement gap may allow the UE to measure all potentially transmitted beams enabling the UE to detect new SSBs/neighbor cells or change in radio conditions. The RRC can also configure to the UE a new condition to send a measurement gap fall back assistance information. At 608, the UE can acknowledge the MeasGap change through RRC Configuration complete.

At 609, in certain embodiments, the UE can detect that the beam measurements within the measurement gaps are changing. For example, the UE may detect that the beams measured using the measurement gap have decreased below a certain threshold, L1_b1<Thr1. L1_b1 can refer to the L1-RSRP measurement of beam 1. Threshold Thr1 can be different from, or the same as, threshold Thr used at 603.

In view of the results at 609, at 610 the UE can send a fallback request to initial measurement gap. The UE can be configured to send UE assistance information when the measurement gap configured at 607 may not be valid anymore.

At 611, the network RRC layer can send a reduced MeasGap configuration to the UE. At 612, the UE can acknowledge the MeasGap change through an RRC Configuration complete message.

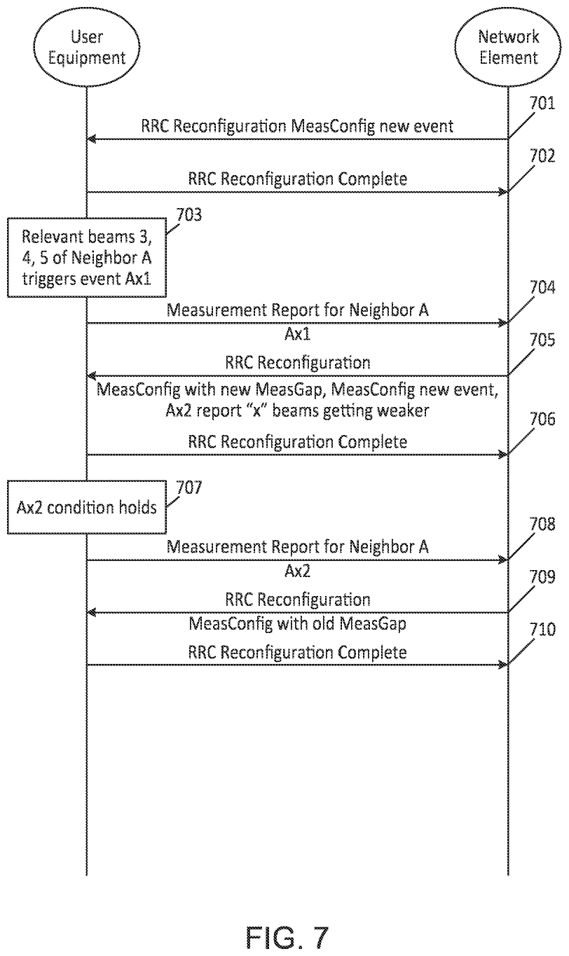

FIG. 7 illustrates another signal flowchart according to certain embodiments. More particularly, FIG. 7 illustrates a chart of a sequence of messages incorporating new event configuration. The messages shown can be between a user equipment and a network element, such as a gNB of a serving cell.

As shown in FIG. 7, at 701, the RRC of the network element can configure the UE with a measurement gap through an RRC configuration message. Initially, the network can include a MeasGap length configured to sweep all SSBs. The RRC can also configure a new measurement event, Ax1, to report the number of relevant contiguous beams and the initial beam id.

Event Ax1, may be that N contiguous beams of a neighbor cell >thr2. This thr2 may be independent from the thr2 in the example of FIG. 7. At 702, the UE can acknowledge the MeasGap configuration with an RRC reconfiguration complete procedure.

At 703, the UE can perform measurements related to the measurement configuration that came with the measurement gap configuration at 701. In one embodiment, for example, the UE can detect that the MeasGap can be optimized. For example, a certain number of beams measured with a measurement gap may be found to be below a certain threshold, for example, L1_b1, L1_b2, . . . L1_b4<Thr. This threshold, Thr, may be different from the similarly named threshold in the example of FIG. 6.

At 704, the UE can send the measurement report triggered by the event Ax1 to the NW. Accordingly, the RRC in the network element can, at 705, send a reduced MeasGap configuration to the UE. This configuration can instruct the UE to take one or more of the following example actions. For example, the configuration can indicate to reduce the size of the measurement gap, such as from 5 ms to 2 ms, for a reduction from covering 8 to 3 SSB beams. The configuration can also indicate to reduce or increase the measurement gap periodicity with respect to change in the beam RSRPs. The configuration can further indicate to change to measurement gap offset, such as from symbol 2, to symbol 36 in case of starting from beam 6 instead of beam 1. The configuration can additionally include, for example, to switch to full measurement gap length configuration covering the full SMTC with a periodicity of, for example, 1 or 5 out of 10 or 50 measurement gap repetitions. The full measurement gap may allow the UE to measure all potentially transmitted beams enabling the UE to detect new SSBs/neighbor cells or change in radio conditions. The configuration at 705 can further identify a new event to ask a measurement gap fall back is configured to the UE. The new event, Event Ax2, can be triggered by at least a beam out of the N of a neighbor cell <thr2. This may be different thr2 than discussed above.

At 706, the UE can acknowledge the MeasGap change through an RRC Configuration complete message.

In certain embodiments, at 707 the condition for event Ax2 may hold or otherwise occur and the UE may determine that the condition is met. Accordingly, at 708, the UE can send a measurement report triggered by the Ax2 event.

In response to the measurement report at 708, the RRC of the network element may, at 709, send a reduced MeasGap configuration to the UE. At 710, the UE can acknowledge the MeasGap change through RRC Configuration complete.

In one alternative, the above approaches can also be realized for the use of concurrent measurement gap patterns and/or pre-configured measurement gap patterns.

Certain embodiments may provide various benefits and/or advantages. For example, certain embodiments may minimize throughput degradation thanks to optimized measurement gaps while maintaining neighbor cell monitoring reliability.

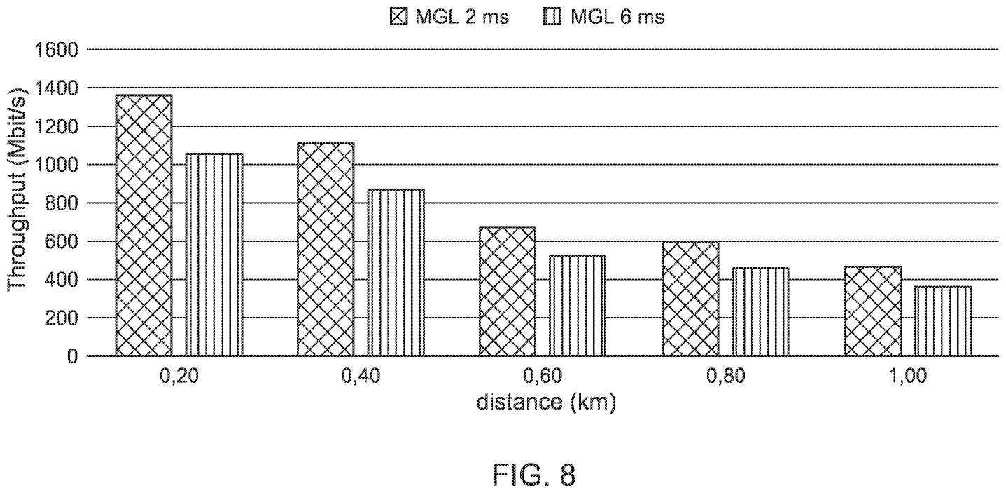

FIG. 8 illustrates simulation results from a reduction in measurement gap length, according to certain embodiments. As can be seen from FIG. 8 there can be improvement seen to a UE in various distances to BS, as to throughput for a bandwidth 40 MHz UE configured with measurement gap repetition period (MGRP) of 20 ms and MGL of 6 ms and 2 ms, thanks to reduction due to certain embodiments.

In the illustrated simulations, the spectral efficiency is calculated in accordance with existing standards for communication. The throughput is calculated for a single time-instance. 8-layer downlink transmission is assumed with varying modulation and coding rate with respect to the distance of the UE to the base station. Friis pathloss model is considered and a noise floor of −96 dBm is assumed for 2.1 GHz carrier frequency and 10 dBm transmit power with no additional receive or transmission antenna gain. No interference is assumed. Modulation and coding scheme (MCS) spectral efficiency versus signal to noise ratio (SNR) is assumed to vary between 0.15 to 5.5 bits/second/Hz. An overhead of 2 symbols for each 14 symbols are assumed for each slot. A scaling factor of 1 is used assuming a generic UE. It was assumed that the UE can be allocated all the bandwidth and the UE has a full buffer.

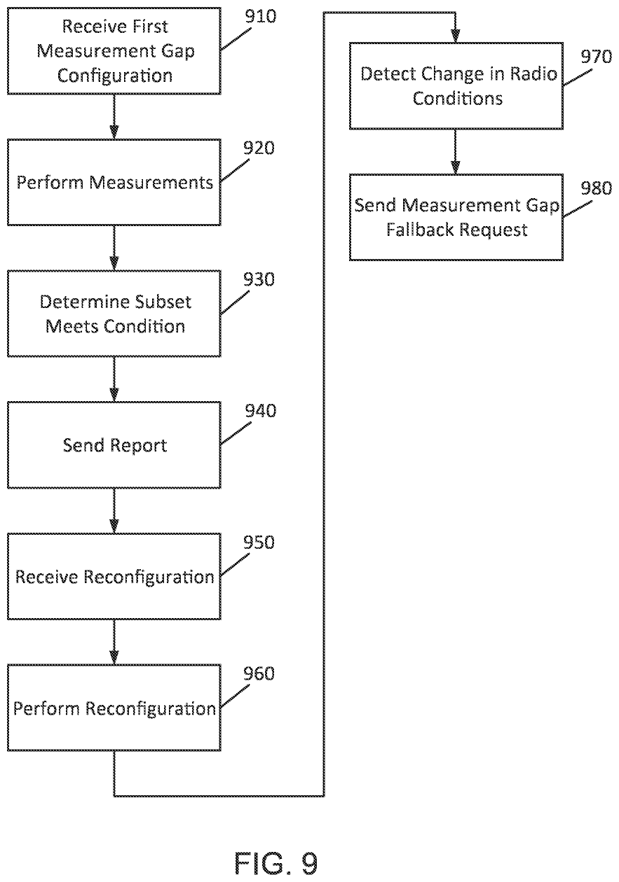

FIG. 9 illustrates an example flow diagram of a method for providing network-controlled measurement gap adaptation for a user equipment, according to certain embodiments.

The method can include, at 910, receiving, by a user equipment from a network element, a first measurement gap configuration. The method can also include, at 920, performing, by the user equipment, measurements on a set of beams that can include a first plurality of beams based on the first measurement gap configuration.

The method can further include, at 930, determining, by the user equipment, that a subset of the beams comprising a second plurality of beams meets a condition. The method can additionally include, at 940, sending, by the user equipment, a report to the network element based on the determination that the subset of the beams meets the condition. The report can be configured to trigger a reconfiguration of the first measurement gap configuration.

The method can also include, at 950, receiving, by the user equipment, the reconfiguration of the first measurement gap configuration from the network element.

The method can further include, at 960, performing, by the user equipment, the reconfiguration.

The method can additionally include, at 970, detecting, by the user equipment, a change in radio conditions after the reconfiguration. The method can also include, at 980, sending, by the user equipment, a measurement gap fallback request to the network element.

It is noted that FIG. 9 is provided as one example embodiment of a method or process. However, certain embodiments are not limited to this example, and further examples are possible as discussed elsewhere herein.

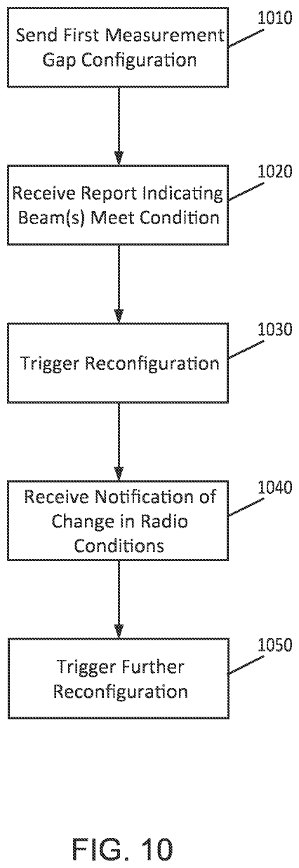

FIG. 10 illustrates an example flow diagram of a method for providing network-controlled measurement gap adaptation for a user equipment, according to certain embodiments.

The procedures of FIG. 9 may be performed by a network element, for example a gNB, while the procedures of FIG. 10 may be performed by a user equipment. The procedures performed by the network element and user equipment can be performed in combination with each other or separately from one another.

The method can include, at 1010, sending, by a network element to a user equipment, a first measurement gap configuration. The user equipment can be configured to perform measurements on a set of beams that can include a first plurality of beams based on the first measurement gap configuration.

The method can also include, at 1020, receiving, by the network element, a report indicating that a subset of the beams that includes a second plurality of beams meets a condition.

The method can further include, at 1030, triggering, by the network element, a reconfiguration of the first measurement gap configuration for the user equipment based on the report.

The method can additionally include, at 1040, receiving, by the network element, a notification of a change in radio conditions from the user equipment after the reconfiguration. The notification can include a measurement gap fallback request to the network element.

The method can also include, at 1050, triggering, by the network element, a further reconfiguration of the measurement to the first measurement gap configuration.

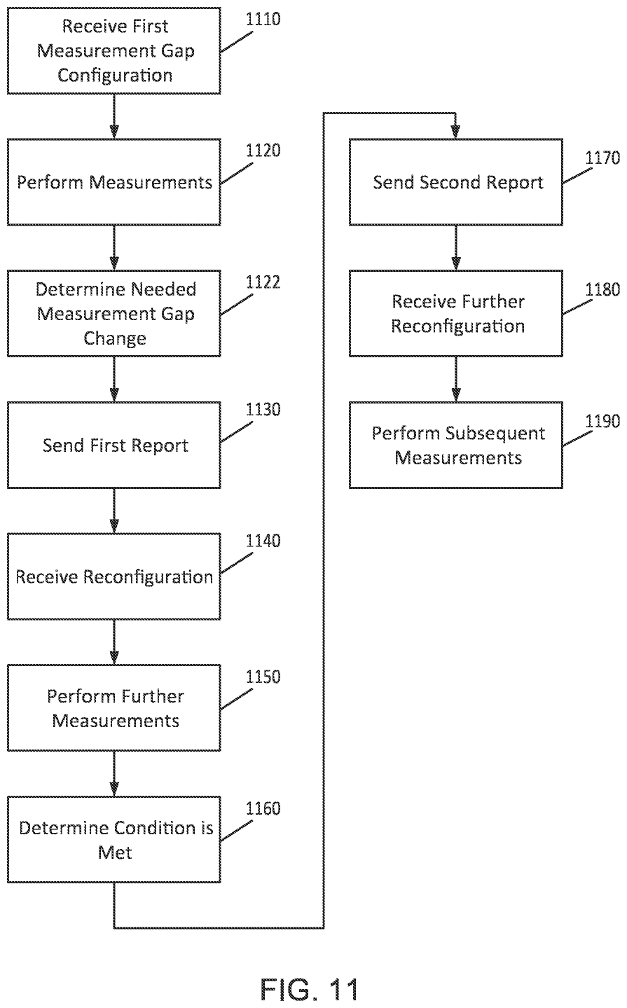

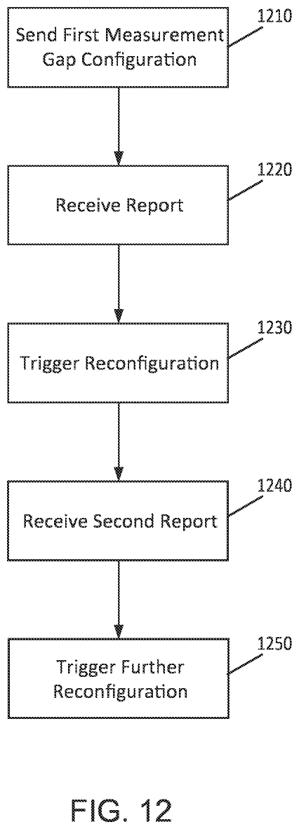

It is noted that FIG. 10 is provided as one example embodiment of a method or process. However, certain embodiments are not limited to this example, and further examples are possible as discussed elsewhere herein. The methods of FIGS. 9 and 10 can be implemented, for example, using the signal flow shown in FIG. 6 By contrast, the methods of FIGS. 11 and 12, discussed below, can be implemented, for example, using the signal flow shown in FIG. 7.

FIG. 11 illustrates an example flow diagram of a method for providing network-controlled measurement gap adaptation for a user equipment, according to certain embodiments.

The method can include, at 1110, receiving, by a user equipment from a network element, a first measurement gap configuration and a measurement report condition, for example, a measurement report condition to detect a measurement gap change. The method can also include, at 1120, performing, by the user equipment, measurements on a set of beams that can include a first plurality of beams based on the first measurement gap configuration.

Moreover, the method can include, at 1122, determining, using the measurement report condition, that a change of measurement gap is needed. The method can further include, at 1130, sending, by the user equipment, a first report of the measurements to the network element, indicating a change of the measurement gap. The method can additionally include, at 1140, receiving, by the user equipment, a reconfiguration message from the network element with a new measurement gap based on the report. The reconfiguration message can further identify a condition regarding measurements. The method can additionally include, at 1150, performing, by the user equipment, further measurements based on the new measurement gap. The method can also include, at 1160, determining, by the user equipment, that the condition is met. The method can further include, at 1170, sending, by the user equipment, a second report to the network element including the further measurements and an indication that the condition is met.

The method can also include, at 1180, receiving, by the user equipment, a further reconfiguration message based on the second report. The further reconfiguration message can indicate usage of the first measurement gap configuration. The method can further include, at 1190, performing, by the user equipment, subsequent measurements based on the first measurement gap configuration responsive to the further reconfiguration message.

It is noted that FIG. 11 is provided as one example embodiment of a method or process. However, certain embodiments are not limited to this example, and further examples are possible as discussed elsewhere herein.

FIG. 12 illustrates an example flow diagram of a method for providing network-controlled measurement gap adaptation for a user equipment, according to certain embodiments.

The method can include, at 1210, sending, by a network element to a user equipment, a first measurement gap configuration and a measurement report condition to detect a measurement gap change. The method can also include, at 1220, receiving, by the network element, a first report of measurements performed on a set of beams that can include a first plurality of beams based on the first measurement gap configuration.

The method can further include, at 1230, triggering, by the network element, reconfiguration of the user equipment with a reconfiguration message. The reconfiguration message can include a new measurement gap based on the report. The reconfiguration message can further identify a condition regarding measurements.

The method can additionally include, at 1240, receiving, by the network element, a second report indicating further measurements performed based on the new measurement gap and an indication that the condition is met. The method can also include, at 1250, triggering, by the network element, reconfiguration of the user equipment with a further reconfiguration message based on the second report. The further reconfiguration message can indicate usage of the first measurement gap configuration.

The procedures of FIG. 11 may be performed by a network element, for example a gNB, while the procedures of FIG. 12 may be performed by a user equipment. The procedures performed by the network element and user equipment can be performed in combination with each other or separately from one another.

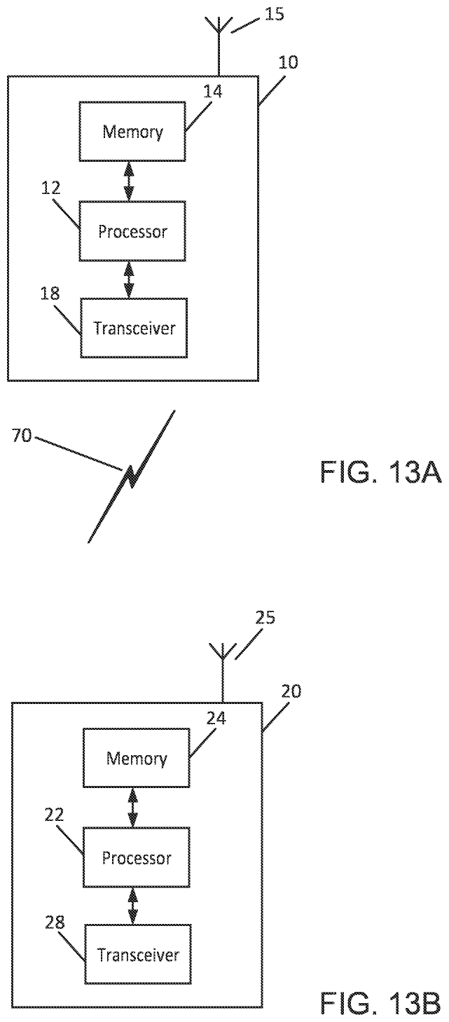

FIG. 13A illustrates an example of an apparatus 10 according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may comprise an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 13A.

As illustrated in the example of FIG. 13A, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 13A, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 1-12, or any other method described herein. In some embodiments, as discussed herein, apparatus 10 may be configured to perform a procedure relating to providing network-controlled measurement gap adaptation, for example.

FIG. 13B illustrates an example of an apparatus 20 according to another embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 13B.

As illustrated in the example of FIG. 13B, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 13B, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIGS. 1-12, or any other method described herein. For example, in an embodiment, apparatus 20 may be controlled to perform a process relating to providing network-controlled measurement gap adaptation, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. Certain embodiments may have various benefits and advantages. For example, certain embodiments may minimize throughput degradation thanks to optimized measurement gaps while maintaining neighbor cell monitoring reliability.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### Partial Glossary

CU Centralized Unit
DU Distributed Unit
MCS Modulation and Coding Scheme
MG Measurement Gap
MGL Measurement Gap Length
MGRP Measurement Gap Repetition Period
MPUE Multi Panel UE
RRC Radio Resource Control
RSRP Reference Signal Receive Power
RSRQ Reference Signal Received Quality
SINR Signal-to-interference-plus-noise ratio
SMTC SSB-based RRM Measurement Timing Configuration
SSB Synchronization Signal Block
UE User Equipment
UL Uplink

1. An apparatus, comprising:
at least one processor; and
at least one memory comprising computer program code,
the at least one memory and computer program code configured, with the at least one processor, to cause the apparatus at least to perform:
receiving, from a network element, a first measurement gap configuration;
performing measurements on a set of beams, comprising a first plurality of beams, based on the first measurement gap configuration;
determining that a subset of the beams comprising a second plurality of beams meets a condition; and
sending a report to the network element based on the determination that the subset of the beams meets the condition, wherein the report is configured to trigger a reconfiguration of the first measurement gap configuration.

2. The apparatus of claim 1, wherein the condition comprises the reference signal received power of the second plurality of beams being lower than a predetermined threshold

3. The apparatus of claim 1, wherein the at least one memory and computer program code are configured, with the at least one processor, to cause the apparatus at least to perform:
receiving the reconfiguration of the first measurement gap configuration from the network element; and
performing the reconfiguration.

4. The apparatus of claim 3, wherein the at least one memory and computer program code are configured, with the at least one processor, to cause the apparatus at least to perform:
detecting a change in radio conditions after the reconfiguration; and
sending a measurement gap fallback request to the network element.

5. The apparatus of claim 4, wherein the detecting the change in radio conditions comprises detecting that the reference signal received power of the second plurality of beams are lower than a predetermined threshold.

6. The apparatus of claim 4, wherein the measurement gap fallback request is configured to trigger fallback to the first measurement gap configuration or another measurement gap configuration.

7. An apparatus, comprising:
at least one processor; and
at least one memory comprising computer program code,
the at least one memory and computer program code configured, with the at least one processor, to cause the apparatus at least to perform:
receiving, from a network element, a first measurement gap configuration and a measurement report condition to detect a measurement gap change;
performing measurements on a set of beams, comprising a first plurality of beams, based on the first measurement gap configuration;
determining, using the measurement report condition, that a change of measurement gap is needed;
sending a first report of the measurements to the network element, indicating a change of the measurement gap; and
receiving a reconfiguration message from the network element with a new measurement gap based on the report.

8. The apparatus of claim 7, wherein the reconfiguration message further identifies a condition regarding measurements.

9. The apparatus of claim 8, wherein the at least one memory and computer program code are configured, with the at least one processor, to cause the apparatus at least to perform:
performing further measurements based on the new measurement gap;
determining that the condition is met; and
sending a second report to the network element including the further measurements and an indication that the condition is met.

10. The apparatus of claim 9, wherein the at least one memory and computer program code are configured, with the at least one processor, to cause the apparatus at least to perform:
receiving a further reconfiguration message based on the second report, wherein the further reconfiguration message indicates usage of the first measurement gap configuration; and
performing subsequent measurements based on the first measurement gap configuration responsive to the further reconfiguration message.

11. An apparatus, comprising:
at least one processor; and
at least one memory comprising computer program code,
the at least one memory and computer program code configured, with the at least one processor, to cause the apparatus at least to perform:
sending, to a user equipment, a first measurement gap configuration, wherein the user equipment is configured to perform measurements on a set of beams, comprising a first plurality of beams, based on the first measurement gap configuration;
receiving a report indicating that a subset of the beams comprising a second plurality of beams meets a condition; and
triggering a reconfiguration of the first measurement gap configuration for the user equipment based on the report.

12. The apparatus of claim 11, wherein the at least one memory and computer program code are configured, with the at least one processor, to cause the apparatus at least to perform:
receiving a notification of a change in radio conditions from the user equipment after the reconfiguration, wherein the notification comprises a measurement gap fallback request to the network element; and
triggering a further reconfiguration of the measurement to the first measurement gap configuration.

13-42. (canceled)
